(19) United States
(12) Patent Application Publication
(10) Pub. No.: US 2026/0331323 A1
(43) Pub. Date: Oct. 22, 2026

(54) PROCESS AND METHOD FOR SELECTIVE RECOVERY OF URANIUM, MOLYBDENUM, NEPTUNIUM, AND OTHER ELEMENTS FROM USED NUCLEAR FUEL USING FLOURIDE VOLATILITY

(71) Applicant: CURIO SOLUTIONS, LLC, Inwood, NY (US)

(72) Inventors: Vikram Singh, Alexandria, VA (US); Cemal Cakez, Fairfax, VA (US); Alexander McGuire Wheeler, Silver Spring, MD (US)

(73) Assignee: CURIO SOLUTIONS, LLC, Inwood, NY (US)

(21) Appl. No.: 19/570,723

(22) Filed: Mar. 18, 2026

Related U.S. Application Data
(60) Provisional application No. 63/775,649, filed on Mar. 21, 2025.

(51) Int. Cl. G21G 1/00; B01J 8/18; G21G 1/02

(52) U.S. Cl. CPC G21G 1/001; B01J 8/1809; B01J 8/1836; B01J 8/1845; G21G 1/02; G21G 2001/0036; G21G 2001/0094

(57) ABSTRACT

A system for recovering decontaminated uranium as UF₆ from a used nuclear fuel (UNF) matrix has a vessel. A particle bed is formed in an interior of the vessel and contains a solid dilutant medium and UNF in a pulverized form. At least one gas inlet is formed in a bottom area of the vessel injecting a fluorinating agent into the vessel. A diffuser plate is located at a bottom of the vessel and coupled to the at least one gas inlet mixing the fluorinating agent, the solid dilutant medium, and the UNF in a pulverized form promoting fluidization. At least one gas outlet is formed on a top area of the vessel discharging off gases and product UF₆ gases out of the vessel. A heating unit is coupled to an outer surface of the vessel to maintain temperatures and avoid premature condensation of the various product gases.

### RELATED APPLICATIONS

This patent application is related to U.S. Provisional Application No. 63/775,649 filed Mar. 21, 2025, entitled “A PROCESS AND METHOD FOR SELECTIVE RECOVERY OF URANIUM, MOLYBDENUM, NEPTUNIUM, AND OTHER ELEMENTS FROM USED NUCLEAR FUEL USING FLUORIDE VOLATILITY”, in the names of the same inventors which is incorporated herein by reference in its entirety. The present patent application claims the benefit under 35 U.S.C § 119(e) of the aforementioned provisional application.

### BACKGROUND

The U.S. commercial nuclear power sector has generated approximately 96,000 metric tons of used nuclear fuel (UNF), which may present both an environmental challenge and which may present a significant untapped energy source. Recycling the UNF may be a means to recover economically valuable materials while minimizing the quantity of high-level waste destined for geologic disposal. The pulverized product may be subjected to a variety of actinide separation processes. However, for process efficiency, the bulk UNF component—uranium—should be recovered with minimal contamination.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a system for recovering decontaminated uranium as UF₆ from a used nuclear fuel (UNF) matrix is provided. The system has a vessel. A particle bed is formed in an interior of the vessel and contains a solid dilutant medium and UNF in a pulverized form. At least one gas inlet is formed in a bottom area of the vessel injecting a fluorinating agent into the vessel. A diffuser plate is located at a bottom of the vessel and coupled to the at least one gas inlet mixing the fluorinating agent, the solid dilutant medium, and the UNF in a pulverized form promoting fluidization. At least one gas outlet is formed on a top area of the vessel discharging off gases and product UF₆ gases out of the vessel. A heating unit is coupled to an outer surface of the vessel to maintain temperatures and avoid premature condensation of the various product gases.

According to an embodiment of the disclosure, a system for recovering decontaminated uranium as UF₆ from a used nuclear fuel (UNF) matrix is provided. The system has a vessel, wherein the vessel takes the form of a fluidized bed reactor. A particle bed is formed in an interior of the vessel and contains a solid dilutant medium and UNF in a pulverized form. At least one gas inlet is formed in a bottom area of the vessel injecting a fluorinating agent into the vessel, wherein the fluorinating agent is nitrogen trifluoride (NF₃) diluted with an inert gas. A diffuser plate is located at a bottom of the vessel and coupled to the at least one gas inlet mixing the fluorinating agent, the solid dilutant medium, and the UNF in a pulverized form promoting fluidization, wherein the diffuser plate injects the fluorinating agent at different partial pressures for fluidization in different regimes for different powder sizes. A plurality of nozzles is coupled to the diffuser plate. At least one gas outlet is formed on a top area of the vessel discharging off gases and product UF₆ gases out of the vessel. A filter unit is positioned in a top area of the interior of the vessel removing particulates from the off gases and the product UF₆ gases. A heating unit coupled to an outer surface of the vessel to maintain temperatures and avoid premature condensation of the various product gases, wherein the heating unit comprises a jacket of heat pipes coupled to the outer surface of the vessel for controlling temperatures in the vessel.

According to another embodiment of the disclosure, a method for recovering decontaminated uranium as UF₆ from a used nuclear fuel (UNF) matrix is provided. The method comprising: placing UNF in a pulverized form in a fluidized bed reactor, wherein the fluidized bed reactor comprises: a vessel; a particle bed formed in an interior of the vessel and containing a solid dilutant medium and the UNF in a pulverized form, wherein the solid diluent medium comprises particles of at least one of: alumina, CaF₂, nickel, and combinations thereof; at least one gas inlet port formed in a bottom area of the vessel; a diffuser plate located at a bottom of the vessel coupled to the at least one gas inlet port; a plurality of nozzles coupled to the diffuser plate; at least one gas outlet port formed on a top area of the vessel discharging off gases and product UF₆ gases out of the vessel; a filter unit positioned in a top area of the interior of the vessel removing particulates from the off gases and the product UF₆ gases; and a heating unit coupled to an outer surface of the vessel to maintain temperatures and avoid premature condensation of the various product gases, wherein the heating unit comprises a jacket of heat pipes coupled to the outer surface of the vessel for controlling temperatures in the vessel; injecting a fluorinating agent into the vessel, wherein the fluorinating agent is nitrogen trifluoride (NF₃) diluted with an inert gas; and mixing the fluorinating agent, the solid dilutant medium, and the UNF in a pulverized form promoting fluidization, wherein the diffuser plate injects the fluorinating agent at different partial pressures for fluidization in different regimes for different powder sizes.

### BRIEF DESCRIPTION OF THE DRAWINGS

FIG. 1 is a perspective view of an exemplary fluidized bed setup used for testing, in accordance with an embodiment of the disclosure;

FIG. 2 is an exemplary thermogravimetric plot of volatilization of uranium oxide showing mass change as the reaction proceeds through formation of uranium oxyfluoride, in accordance with an embodiment of the disclosure;

FIG. 3 is an exemplary plot showing pressure difference (top vs. bottom of vessel) vs. inlet gas velocity showing the resistance of particles against gas flow is saturated when reaching a fluidized state, in accordance with an embodiment of the disclosure;

FIG. 4 is a cross-sectional view of an exemplary fluorination vessel, in accordance with an embodiment of the disclosure;

FIG. 5 is an exemplary flow diagram showing lab-scale conversion of UO₂ to U₃O₈ to UO₂ to UF₄ to UF₆ demonstrating selective volatility of uranium-oxide SIMFUEL containing Pu and Np, in accordance with an embodiment of the disclosure;

FIG. 6 is a perspective view of an exemplary diffuser plate with nozzles, in accordance with an embodiment of the disclosure;

FIG. 7 is a perspective view of an exemplary filter unit, in accordance with an embodiment of the disclosure;

FIG. 8 is a perspective view of an exemplary lid, in accordance with an embodiment of the disclosure; and

FIG. 9 is a perspective view of an exemplary heating unit, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

With the goal of acquiring a uranium product that can be readily reincorporated into the existing front-end of the fuel cycle and avoid post-processing, it may be desirable to consider harnessing uranium's volatility to recover it as uranium hexafluoride (UF₆). Several fluorinating agents have been demonstrated for this purpose, such as fluorine gas (F₂) and liquid chlorine trifluoride (ClF₃). However, selective fluoride volatility (SFV) in NuCycle utilizes nitrogen trifluoride (NF₃) which is both safer to handle in large quantities and possesses unique temperature-based reactivity. Pulverized triuranium octoxide (U₃O₈) can either be directly contacted with NF₃ or converted into uranium tetrafluoride (UF₄) through a reduction and hydrofluorination process. Either way, the resulting powder is contacted with NF₃ at different temperatures which may selectively volatilize different components, resulting in the recovery of uranium as uranium hexafluoride (UF₆) which is highly decontaminated from the other volatile components such as transition metal or transuranic fluorides.

The present disclosure deals with recovery of highly decontaminated uranium as UF₆ from a UNF matrix. This UNF matrix material containing uranium, fission products, plutonium, and minor actinides is recovered from any nuclear reactor. The presented process can accommodate UNF in oxide or metal form. Given that the reaction is a solid-gas reaction, the presented process requires that the UNF matrix be converted into a pulverized form.

Such pulverization processes may proceed as follows:
1. For metal fuel, the material may be hydrided and de-hydrided to pulverize it.
2. For metal fuel, especially U—Al, U—Zr, U—Mo, or similar alloys, the material can be subjected to chloride volatility which would remove the alloying element as a chloride vapor and render the uranium in pulverized chloride form. This uranium chloride can react with HF to form uranium fluoride particles which are then subjected to the presented process.
3. For oxide fuel, the UNF may be physically pulverized to render UO₂ particles of a uniform size distribution which can be subjected to the process.
4. For oxide fuel, the UNF may react with oxygen to convert UO₂ to U₃O₈ and pulverize in the process. This pulverized U₃O₈ can be subjected to the presented process
5. For oxide fuel, the UNF converted to U₃O₈ via oxidation may be reduced with H₂, NH₃, or similar reducing agent to recover pulverized UO₂ which can be subjected to the process.
6. For oxide fuel, the UNF converted to U₃O₈ and then to UO₂ through oxidation and reduction can then be reacted with HF to convert the UO₂ to UF₄ which can then be subjected to the presented process.

There are multiple reaction pathways of NF₃ with various uranium compounds (as well as other elements present in the UNF), all of which may display temperature-based stratification. The Gibbs free energy of principal reactions of various uranium compounds with NF₃ is presented below (at 500 °C)—equations 1-5.

UO₂+2NF₃(g)→UF₆(g)+2NO(g)ΔG_{r×n}=−774(kJ·mol⁻¹U) Eq. 1

U₃O₈+6NF₃(g)→3UF₆(g)+6NO(g)+O₂(g)ΔG_{r×n}=−706(kJ·mol⁻¹U) Eq. 2

3UF₄+2NF₃(g)→3UF₆(g)+N₂(g)ΔG_{r×n}=−232(kJ·mol⁻U) Eq. 3

NpO₂+2NF₃(g)→NpF₆(g)+2NO(g)ΔG_{r×n}=−547(kJ·mol⁻¹U) Eq. 4

U+2NF₃(g)→UF₆(g)+N₂(g)ΔG_{r×n}=−1886(kJ·mol⁻U) Eq. 5

In all cases, it may be seen that the reactions are highly exothermic. Given that the goal of the process is to recover uranium using the temperature-based selectivity of the reagent, the exothermicity of the reaction may pose a challenge. Hence, the reactor of choice for this process may be a fluidized bed reactor.

For temperature management and reaction moderation, the fluidized bed reactor may be provided with a solid diluent medium. This may take the form of particles of alumina, CaF₂, nickel, and similar compositions. The diluent occupies the larger share of the reactor bed volume at the start of the reaction (e.g., 3:1 or 4:1 diluent to UNF ratio) with the diluent occupying larger volume fraction as the reaction progresses toward completion. Thus, the fluidization properties of the reactor may be dependent on the diluent particle properties and only weakly sensitive to the UNF. This may allow any combination of the above uranium compounds and diluents to be utilized in assembling the reactor.

In the case of uranium oxide as the starting material, lab-scale testing showed that the UF₆ was complexed with nitrogen oxide at the temperatures at which the reaction occurred. This UF_{5/6}—NOₓ complex may form a solid deposit which may require appropriately designed capture systems. In such a configuration, the NOx complexes are weak and controlled heating of the product may drive off the NOx leaving behind a mixture of UF₄, UF₅, and UF₆. Upon reacting again with a fluorinating agent, in this case NF₃, the uranium fluoride (in IV, V, and VI oxidation states) mixture may complete its stoichiometric conversion to UF₆ such that all the uranium is recovered in this U(VI) volatile form. In the case of metallic uranium and uranium converted to UF₄, there is no oxygen present at the time the reaction with NF₃ is conducted and, as a result, there is no formation of nitrogen oxides and the complexation with uranium (V and VI) fluoride is completely avoided. All these reaction pathways can be conducted in the process described herein and covered by this application.

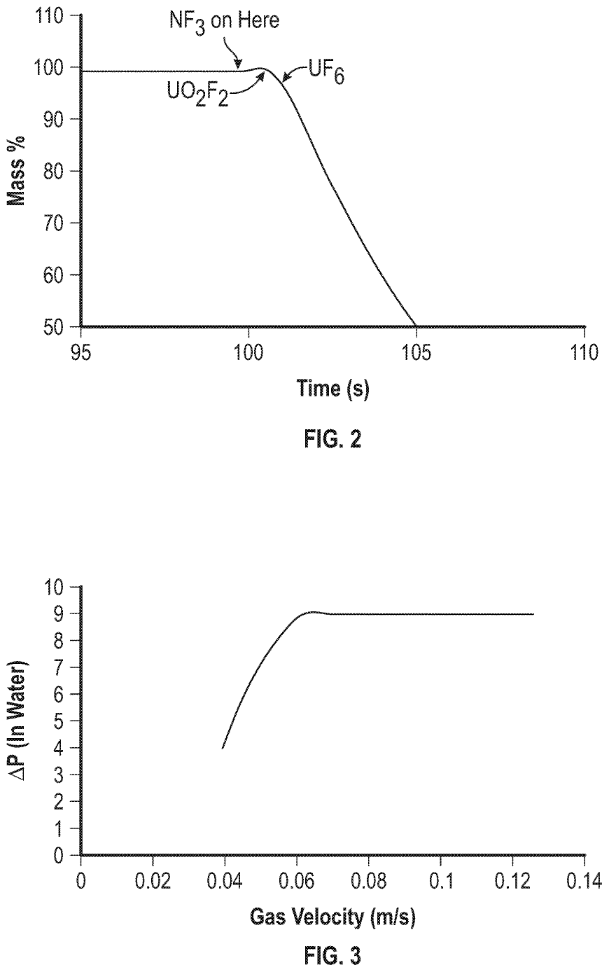

Although NF₃ is a mild fluorinating agent, it has one more fluorine atom per molecule than fluorine gas (F₂). Therefore, it can provide 50% more fluorine atoms for a given volume of the reagent as may be shown in FIG. 2. Nevertheless, NF₃ does not possess sufficient reactivity to convert plutonium (Pu) to its volatile form and maintain it, especially in the presence of uranium and other metals in the mixture which act as a reducing agent for converting PuF₆ (volatile) to PuF₄ (non-volatile). Laboratory-scale testing has demonstrated very high decontamination factors for the uranium such that there is little to no measurable contamination from Pu and Np in the captured UF₆ product.

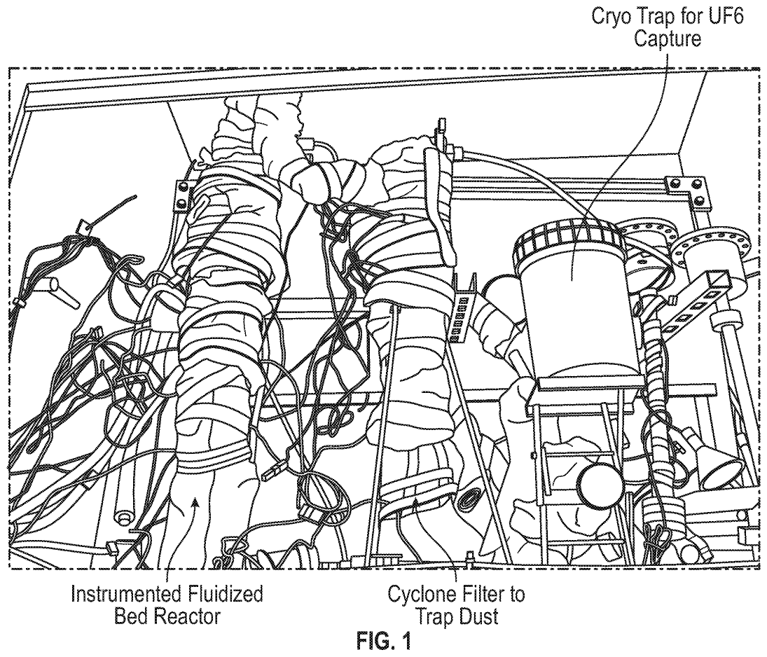

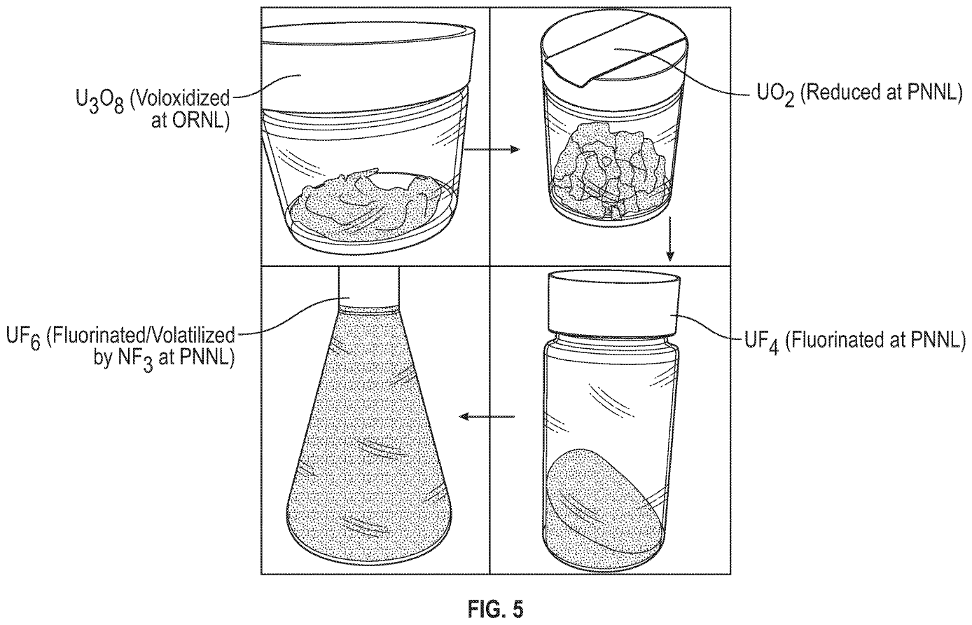

Lab-scale experiments using a fluidized bed setup as shown in FIG. 1 at various scales at Pacific Northwest National Laboratory (PNNL) and Idaho National Laboratory (INL) have assisted in understanding the idiosyncrasies of the fluoride volatility process (see FIGS. 2 and 3) with two viable flow sheets demonstrated in FIG. 5. All lab-scale work showed fission product elements with volatile fluorides separating from the bulk material matrix at temperatures ≤400 °C. Further increases in temperature led to prodigious generation of UF₆. In lab-scale testing, there were two pathways demonstrated.

U₃O₈→UF₅·NOF→UF₆+NOF+N₂ΔG_{r×n}=−8,209(kJ·mol⁻¹U) Eq. 6

U₃O₈→UO₂→UF₄→UF₆ Eq. 7

Both pathways were studied at lab-scale and a pure UF₆ product devoid of fission products and transuranic elements was acquired. As described above, in the first pathway, a chemical complex of UF_{5/6} and NOₓ may form which condenses on cold surfaces. Passing argon over this airy solid complex may remove excess NOₓ and a second round of fluorination yields pure UF₆, rendering any adhering NOₓ as NOF. The other pathway eludes NOₓ formation by converting the U₃O₈ into UF₄ prior to contacting NF₃. This pathway may essentially follow a similar chemistry as the front-end of the nuclear fuel cycle, except for using NF₃ for selective volatilization of the uranium.

The second pathway listed above is the first-choice flowsheet for this process, however all combinations of the reagent and reactant are covered. The UO₂→UF₄→UF₆ pathway may offer historical familiarity with the process chemistry, but also reduction in reagent costs, management of enthalpy release over multiple reaction steps, and preventing the formation of NOₓ complexes. Commercially, NF₃ is produced using ammonia and HF as the reactants. Given that ammonia (as H₂ source) and HF are employed in reduction and hydrofluorination, there may be an economic incentive to adopt this pathway. Additionally, the reactions are very favorable at the expected conditions. Experiences with demonstrating SFV at lab-scale using various reactor scales and geometries showed the importance of the hydrodynamics of the process for effective scale up.

All the chemical reactions described above are solid-gas interactions. Such processes are conducted by “fluidizing” the solid reactant through and evenly distributing the gas through the solid bed. These fluidized-bed reactors are known to have good solid mixing (emulsion-phase), thereby dispersing heat very effectively over the entire bed resulting in minimal temperature gradients. Such reactor designs may be sensitive to the physics of the process, including particle size, shape and density, gas flow rates, absolute temperature, etc., but have been deployed at commercial scales in various industries including in the front-end of the fuel cycle for uranium conversion.

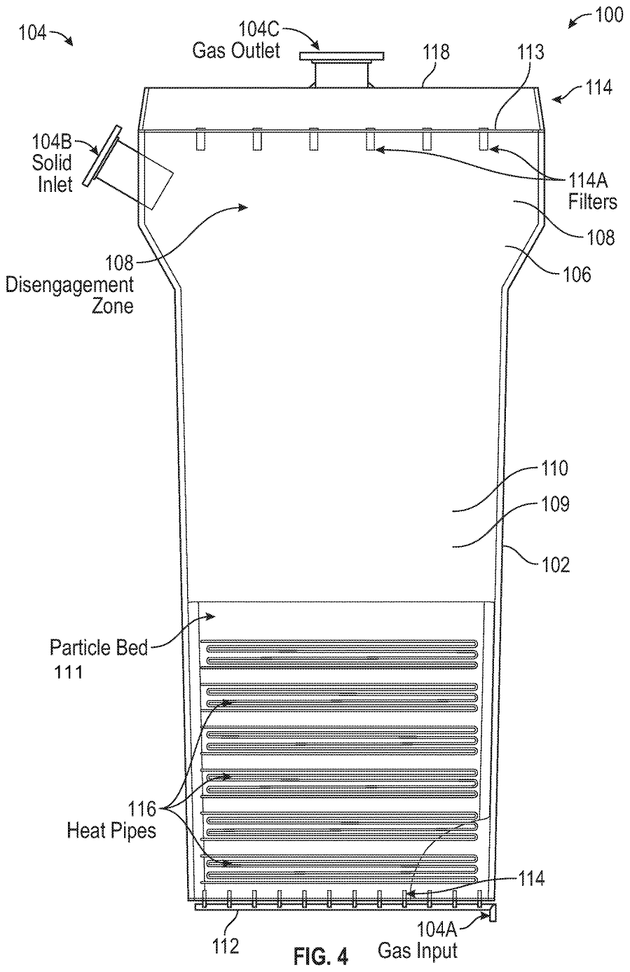

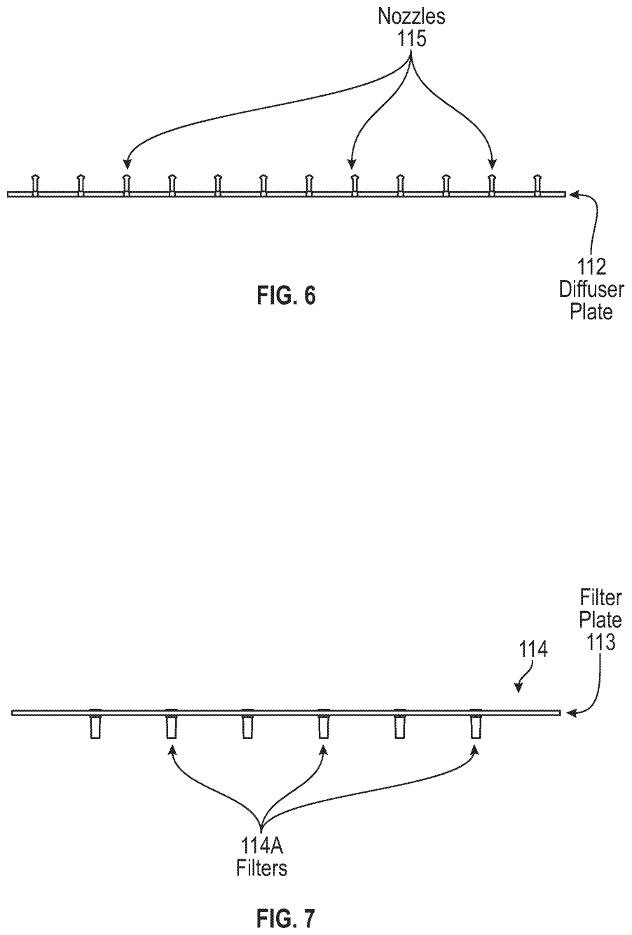

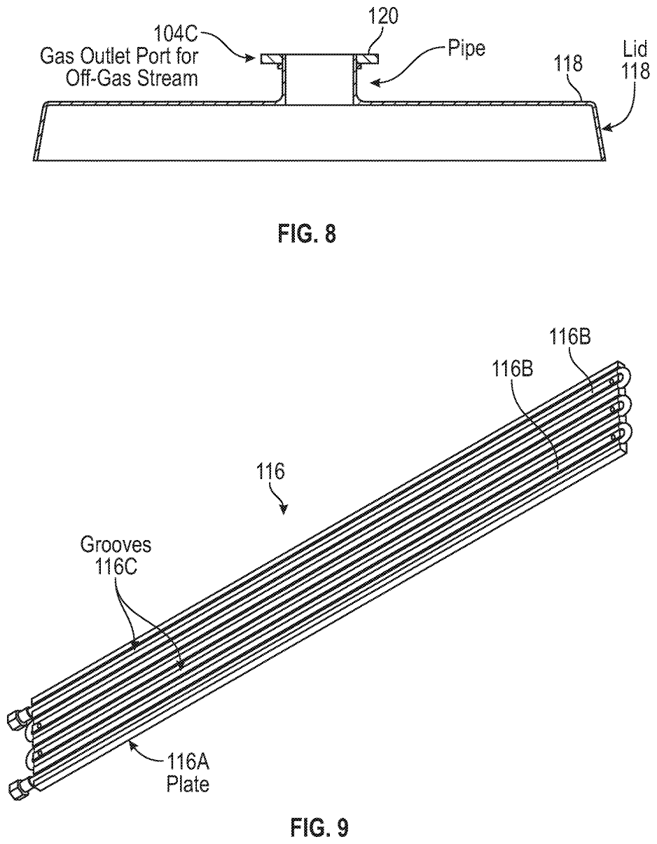

Referring to FIGS. 4 and 6-9, an embodiment of a fluorination vessel 100 may be disclosed. The fluorination vessel 100 may include a main vessel 102 having multiple openings 104 for material transfer. These openings 104 can be in the form of ports, orifices, plugs, flanges, feedthroughs, nipples, joined pipes, Swagelok, or other types of fittings or connections. Auxiliary units for pre- and post-processing units like (hydrofluorinators, purifiers, dryers, heaters, coolers, manifolds, regulators, scrubbers, absorbers, cold traps, rectification sublimation systems, molecular sieves, filters, precipitators, meters, sensors, detectors, etc. ,) and their auxiliaries may also be provided.

The main vessel 102 may be a container formed by a single piece, multiple pieces, connected/joined, framed walls, or similar construction. In accordance with an embodiment, the main vessel 102 may take the form of a fluidized bed reactor. In one embodiment, the fluidized bed reactor may have tapered walls 106 along with a wider disengagement zone 108 above a reaction zone 110. This setup may reduce particle entrainment as the hydraulic diameter changes continuously along the flow path as the gases rise in a reactor column. All surfaces of the main vessel 102 and piping that would be in contact with fluoride-containing compounds are fabricated using a compatible material such as nickel, Hastelloy, Monel, etc., to prevent undue corrosion and provide long reactor lifetime.

The main vessel 102 may have multiple openings 104 for material transfer. The main vessel 102 may have a first inlet 104A. In accordance with one embodiment, the first inlet 104A may be located near a bottom area of the main vessel 102 where the reactant NF₃ gas is introduced diluted in a suitable diluent gas such as argon, nitrogen, etc. The reactant gas mixture is then routed through a diffuser plate 112 containing an array of nozzles 115 of a specific design to allow thorough mixing of gas with the solids and to promote fluidization of the medium,

A second inlet 104B may be formed in a top area of the main vessel 102. The second inlet 104B may be used to introduce solid materials into an interior of the main vessel 102. For example, the solid dilutant medium of a particle bed 111 and UNF in a pulverized form may be injected into the interior of the main vessel 102 via the second inlet 104B, The particle bed 111 is formed in an interior of the main vessel 102, positioned directly above the diffuser plate 112 near the bottom area of the main vessel 102. Pressurized gas or liquid flows upward through the nozzles 115 of the distributor plate 112, suspending the solid dilutant medium (alumina, CaF2, nickel beads, and similar materials) in a dense phase, which creates a boiling-like, fluidized zone 109 in the lower section.

The main vessel 102 may have a set of outlets 104C. In accordance with one embodiment, the outlets 104C may be formed near a top area of the main vessel 102. The outlets 104C may allow for product gases and off gases produced during the process to be removed from the main vessel 102. The set of outlets 104C may have dedicated outlets for volatile transition metal fluorides and for the UF₆. The outgoing gas may be routed through a filter system 114. The filter system 114 may help retain particulates being dragged by the outflowing gas stream.

The fluorination vessel 100 may have heaters 116. The heaters 116 may be positioned on the outer surface of the main vessel 102 and around all associated piping to maintain temperatures and avoid premature condensation of the various product gases.

The diffuser plate 112 may be in gaseous communication with the inlet 104A. In one embodiment, the diffuser plate 112 may be an appropriately shaped plate that holds multiple nozzles 115 and is mounted to the bottom of the main vessel 102. The fluorinating agent at different partial pressures in a diluent gas medium can be introduced through the diffuser plate 112 inside the main vessel 102 for successful fluidization in different regimes for different powder sizes. The diffuser plate 112 may be of sufficient thickness to hold the weight of the reacting materials and diluent present in a batch and conforms to the shape of the cross-section of the bottom of the main vessel 102.

In accordance with one embodiment, the filter system 114 may have a filter plate 113. The filter plate 113 may be positioned in the path of the outflowing gas stream in the main vessel 102 above the reaction zone 110 in the disengagement zone 108 and before the outlet 104C. The filter plate 113 may consists of screw-type connectors onto which the filters 114A can be mounted. In accordance to one embodiment, the filters 114A may be bayonet-type sintered nickel filters. The filter plate 113 may conform to the cross-section of the top of the main vessel 102. The mounted filters 114A may catch particulate matter entrained in the gas flow and prevent fouling of the product gas stream. The bayonet-type sintered-nickel filters may be cleaned using blowback where argon or nitrogen gas flow is reversed through the filter to dislodge particulates adhering to the surface of the bayonet-type sintered-nickel filters.

An alternative to the bayonet-type sintered-nickel filters is to utilize cyclone filters in the immediate path of the outflowing gas to dislodge entrained particulate matter through centrifugal action. In some embodiments, both cyclone filters and bayonet type sintered-nickel filters may be utilized. Finally, the outflowing gas may be routed through electrostatic precipitators to ensure that no fine particulate matter remains entrained in the gas stream.

A lid 118 may be placed on a top area of the main vessel 102 enclosing the main vessel 102. The lid 118 may be composed of similar structural material as the main vessel 102 to match the thermal expansion coefficient and form a gas-tight connection to the main vessel 102. At the top of the lid 118 are one or more gas outlets 104C. The outlets 104C may have a flange fitting 120. The flange fitting 120 may provide for a more secure and leakproof connection.

In accordance with one embodiment, the heaters 116 may be configured as a jacket 116A of heat pipes 116B provided on the outer face of the main vessel 102. The jacket 116A of heat pipes 116B formed may be in thermal contact with the main vessel 102 and may be used to control the temperatures in the reaction zone 110 via heating and cooling. The jacket 116A may also possess some dedicated grooves 116C for cladded heaters which may be used for heating.

Various modifications of the present invention, in addition to those shown and described herein, will be apparent to those skilled in the art of the above description. Such modifications are also intended to fall within the scope of the appended claims.

The foregoing description is illustrative of particular embodiments of the invention but is not meant to be a limitation upon the practice thereof. The following claims, including all equivalents thereof, are intended to define the scope of the invention.

1. A system for recovering decontaminated uranium as UF₆ from a used nuclear fuel (UNF) matrix comprising:
a vessel;
a particle bed formed in an interior of the vessel and containing a solid dilutant medium and UNF in a pulverized form;
at least one gas inlet formed in a bottom area of the vessel injecting a fluorinating agent into the vessel;
a diffuser plate located at a bottom of the vessel coupled to the at least one gas inlet mixing the fluorinating agent, the solid dilutant medium, and the UNF in a pulverized form promoting fluidization;
at least one gas outlet formed on a top area of the vessel discharging off gases and product UF₆ gases out of the vessel; and
a heating unit coupled to an outer surface of the vessel to maintain temperatures and avoid premature condensation of the various product gases.

2. The system of claim 1, wherein the vessel takes the form of a fluidized bed reactor.

3. The system of claim 1, comprising a filter unit positioned in a top area of the interior of the vessel removing particulates from the off gases and the product UF₆ gases.

4. The system of claim 1, comprising a filter unit positioned in a top area of the interior of the vessel removing particulates from the off gases and the product gases, the filter unit comprising:
a filter plate positioned in a top area of the interior of the vessel in a pathway of the at least one gas outlet port; and
a plurality of filters coupled to the filter plate.

5. The system of claim 1, wherein the plurality of filters are a plurality of bayonet-type filters.

6. The system of claim 1, wherein the diffuser plate injects the fluorinating agent at different partial pressures for fluidization in different regimes for different powder sizes.

7. The system of claim 1, comprising a plurality of nozzles coupled to the diffuser plate.

8. The system of claim 1, wherein the fluorinating agent is nitrogen trifluoride (NF₃) diluted with an inert gas.

9. The system of claim 1, wherein the reactant gas is nitrogen trifluoride (NF₃) diluted in a diluent gas, the dilutant gas being one of: argon, nitrogen, and other inert gases.

10. The system of claim 1, wherein the solid diluent medium comprises particles of at least one of: alumina, CaF₂, nickel, and combinations thereof.

11. The system of claim 1, wherein the heating unit comprises a jacket of heat pipes coupled to the outer surface of the vessel for controlling temperatures in the vessel.

12. The system of claim 1, wherein the heating unit comprises a jacket of heat pipes coupled to the outer surface for controlling temperatures in the vessel, wherein the jacket has dedicated grooves for cladded heaters.

13. A system for recovering decontaminated uranium as UF₆ from a used nuclear fuel (UNF) matrix comprising:
a vessel, wherein the vessel takes the form of a fluidized bed reactor;
a particle bed formed in an interior of the vessel and containing a solid dilutant medium and UNF in a pulverized form;
at least one gas inlet formed in a bottom area of the vessel injecting a fluorinating agent into the vessel, wherein the fluorinating agent is nitrogen trifluoride (NF₃) diluted with an inert gas;
a diffuser plate located at a bottom of the vessel coupled to the at least one gas inlet mixing the fluorinating agent, the solid dilutant medium, and the UNF in a pulverized form promoting fluidization, wherein the diffuser plate injects the fluorinating agent at different partial pressures for fluidization in different regimes for different powder sizes;
a plurality of nozzles coupled to the diffuser plate;
at least one gas outlet formed on a top area of the vessel discharging off gases and product UF₆ gases out of the vessel;
a filter unit positioned in a top area of the interior of the vessel removing particulates from the off gases and the product UF₆ gases; and
a heating unit coupled to an outer surface of the vessel to maintain temperatures and avoid premature condensation of the various product gases, wherein the heating unit comprises a jacket of heat pipes coupled to the outer surface of the vessel for controlling temperatures in the vessel.

14. The system of claim 13, comprising a filter unit positioned in a top area of the interior of the vessel removing particulates from the off gases and the product gases, the filter unit comprising:
a filter plate positioned in a top area of the interior of the vessel in a pathway of the at least one gas outlet port; and
a plurality of filters coupled to the filter plate.

15. The system of claim 13, wherein the plurality of filters are a plurality of bayonet-type filters.

16. The system of claim 13, wherein the dilutant gas is one of: argon, nitrogen, and other inert gases.

17. The system of claim 13, wherein the solid diluent medium comprises particles of at least one of: alumina, CaF₂, nickel, and combinations thereof.

18. The system of claim 13, wherein the heating unit comprises a jacket of heat pipes coupled to the outer surface of the controlling temperatures in the vessel, wherein the jacket has dedicated grooves for cladded heaters.

19. A method for recovering decontaminated uranium as UF₆ from a used nuclear fuel (UNF) matrix comprising:
placing UNF in a pulverized form in a fluidized bed reactor, wherein the fluidized bed reactor comprises:
a vessel;
a particle bed formed in an interior of the vessel and containing a solid dilutant medium and the UNF in a pulverized form, wherein the solid diluent medium comprises particles of at least one of: alumina, CaF₂, nickel, and combinations thereof;
at least one gas inlet port formed in a bottom area of the vessel;
a diffuser plate located at a bottom of the vessel coupled to the at least one gas inlet port;
a plurality of nozzles coupled to the diffuser plate;
at least one gas outlet port formed on a top area of the vessel discharging off gases and product UF₆ gases out of the vessel;
a filter unit positioned in a top area of the interior of the vessel removing particulates from the off gases and the product UF₆ gases; and
a heating unit coupled to an outer surface of the vessel to maintain temperatures and avoid premature condensation of the various product gases, wherein the heating unit comprises a jacket of heat pipes coupled to the outer surface of the vessel for controlling temperatures in the vessel;
injecting a fluorinating agent into the vessel, wherein the fluorinating agent is nitrogen trifluoride (NF₃) diluted with an inert gas; and
mixing the fluorinating agent, the solid dilutant medium, and the UNF in a pulverized form promoting fluidization, wherein the diffuser plate injects the fluorinating agent at different partial pressures for fluidization in different regimes for different powder sizes.

20. The method of system of claim 13, comprising filtering particulates from the off gases and the product UF₆ gases.
